(19) United States
(12) Patent Application Publication
(10) Pub. No.: US 2016/0291582 A1
(43) Pub. Date: Oct. 6, 2016

(54) NUMERICAL CONTROLLER HAVING FUNCTION OF AUTOMATICALLY CHANGING WIDTH OF DISPLAYED LETTERS

(71) Applicant: FANUC Corporation, Minamitsuru-gun (JP)

(72) Inventor: Yamato IWAMURA, Minamitsuru-gun (JP)

(21) Appl. No.: 15/070,152

(22) Filed: Mar. 15, 2016

(30) Foreign Application Priority Data
Apr. 3, 2015 (JP) 2015-076424

(51) Int. Cl. G05B 19/4155

(52) U.S. Cl. CPC G05B 19/4155; G05B 2219/32128

(57) ABSTRACT

A numerical controller stores, in a table, a value used in the process of controlling a machine (control-related information) and information that affects the range of possible values of the control-related information, from among information on a setting of the numerical controller and information on the machine. The numerical controller refers to the table, for each of the control-related information, to identify the information that affects the range of possible values of the control-related information and estimates a maximum display number of digits of the control-related information on the basis of the identified information. The numerical controller sets the layout of the displayed control-related information on the basis of the estimated maximum display number of digits of each element.

### BACKGROUND OF THE INVENTION

1. Field of the Invention

The present invention relates to a numerical controller, and particularly to a numerical controller capable of increasing the amount of information to be checked at one time with the information appropriately displayed.

2. Description of the Related Art

Possible values of each element used in a control process carried out by a numerical controller, such as possible offset values of a tool and possible coordinates of the tool, are so specified to fall within a preset range, and when the elements are displayed in a display screen of the numerical controller, the screen is configured to have a layout having areas where the values of the elements are correctly displayed within the respective ranges, and the elements are displayed on the thus configured screen (see Japanese Patent Application Laid-Open No. 2005-044348, for example).

In the display method described above, when the ranges of settable tool radius offset values and tool length offset values are so specified as to range from −9999999.999 to 9999999.999, as shown, for example, in FIG. 5, the area of the displayed tool radius offset and the area of the displayed tool length offset are each set in advance to have a 12-digit display width because a displayed tool radius offset value and tool length offset value each has 12 digits at the longest, and the tool radius offset value and the tool length offset value are displayed in the thus configured areas.

Further, there is a disclosed numerical controller according to related art having a function of setting a movable range for preventing a machine to be controlled from moving to an unintended position and a function of specifying an inputtable range for preventing an incorrect offset value from erroneous input, thereby making an inputtable range to be narrower than the range of possible values of each of the elements described above (see Japanese Patent Application Laid-Open No. 2009-080621, for example).

The range of possible values of each of the elements described above is, however, a range of theoretically possible values and deviates in many cases from a range of values in actual machine control. Therefore, even when the width of a display field is set on the basis of the range of possible values of each of the elements, useless blank spaces that are actually not used, such as those in the tool diameter display fields shown in FIG. 5, are created and undesirably reduce the amount of information displayable on the screen.

### SUMMARY OF THE INVENTION

An object of the present invention is to provide a numerical controller capable of increasing the amount of information to be checked at one time with the information appropriately displayed by displaying data having a width estimated on the basis of settings of a machine and other factors.

A first aspect of a numerical controller according to the present invention has a function of displaying control-related information that is a value used in control process of a machine and includes: a setting information storage area that stores information on a setting of the numerical controller; a machine information acquisition section that acquires information on the machine; a number-of-digits determinant definition table that stores the control-related information and information that affects a range of possible values of the control-related information, from among the information on a setting of the numerical controller stored in the setting information storage area and the information on the machine acquired by the machine information acquisition section, in a state where the control-related information and the information that affects a range of possible values of the control-related information are associated with each other; a display number-of-digits estimation section that refers, for each piece of the control-related information, to the number-of-digits determinant definition table to identify the information that affects a range of possible values of the control-related information and estimates, on the basis of the identified information, a maximum display number of digits of the control-related information; a display layout setting section that sets a display layout on the basis of the maximum display number of digits of each element estimated by the display number-of-digits estimation section; and a display section that displays the elements on the basis of the display layout set by the display layout setting section.

A second aspect of a numerical controller according to the present invention has a function of displaying, in the form of an icon, one or more states of a machine to be controlled by the numerical controller and includes: a setting information storage area that stores information on the machine and information on a setting of the numerical controller; a display target state determination section that determines a state to be displayed, from among the one or more states, on the basis of the setting information storage area; a display layout setting section that sets a display layout on the basis of the number of states to be displayed that is determined by the display target state determination section; and a display section that displays the states to be displayed on the basis of the display layout set by the display layout setting section. The display layout setting section is configured to change a size of each of the icons in accordance with the number of states to be displayed.

According to the present invention, since the width of each displayed element handled by the numerical controller can be suppressed to a width suitable for a possible estimated value of the element, a large amount of information can be displayed at a time on a display screen of the numerical controller, whereby the amount of information to be checked at a time by an operator is increased.

Further, applying the present invention to an inputtable field of the numerical controller allows a prior check of whether the number of digits of a value to be inputted falls within a set range.

### BRIEF DESCRIPTION OF THE DRAWINGS

The object and features of the present invention described above and other objects and features thereof will be apparent from the following description of an example with reference to the accompanying drawings, in which:

FIG. 1 shows an example of elements used in a control process performed by the numerical controller according to the present invention;

FIG. 2 is a functional block diagram of a numerical controller according to an embodiment of the present invention;

FIG. 3 shows an example of a number-of-digits determinant definition table in the numerical controller in FIG. 2;

FIG. 4 describes that the numerical controller according to the present invention is applicable to display of information on an operation state of a machine, a peripheral apparatus connected to the machine, and the like in the form of icons; and

FIG. 5 shows an example of elements used in a control process performed by a conventional numerical controller.

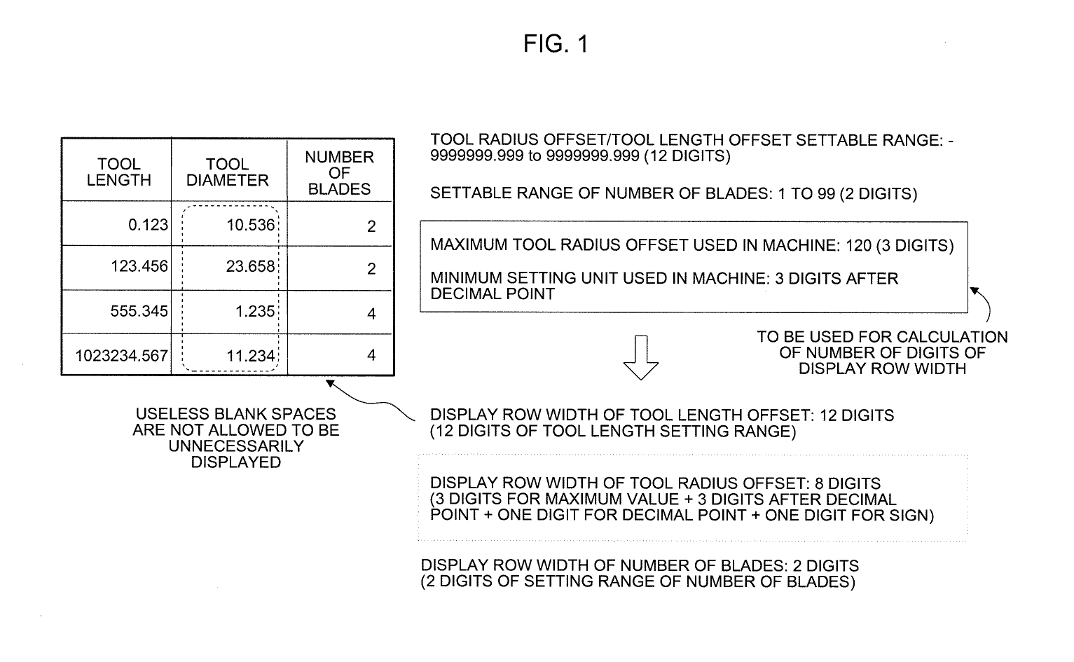

### DETAILED DESCRIPTION OF THE PREFERRED EMBODIMENTS

The present invention provides a numerical controller having a function of estimating, on the basis of information that the numerical controller can acquire, the range of actually possible values of each element (hereinafter referred to as control-related information), such as a tool length offset of a tool to be handled, a tool radius offset of the tool to be handled by the numerical controller, and the position value, used by the numerical controller in a control process and adjusting or otherwise processing a display layout on the basis of the estimated ranges.

For example, when the display layout on a screen that displays the coordinates of a tool is adjusted, the range of possible values of the coordinates is estimated on the basis of information on travel range of a machine tool connected to the numerical controller, a minimum setting unit (information on number of digits after decimal point), an offset value input range, and the like. Further, when the target axis is an axis of rotation, the estimation process is carried out also in consideration of the situation in which the possible range is limited to an angular range from 0 to 360 degrees. The display width of a display field where the coordinates are displayed is then determined on the basis of the estimated range.

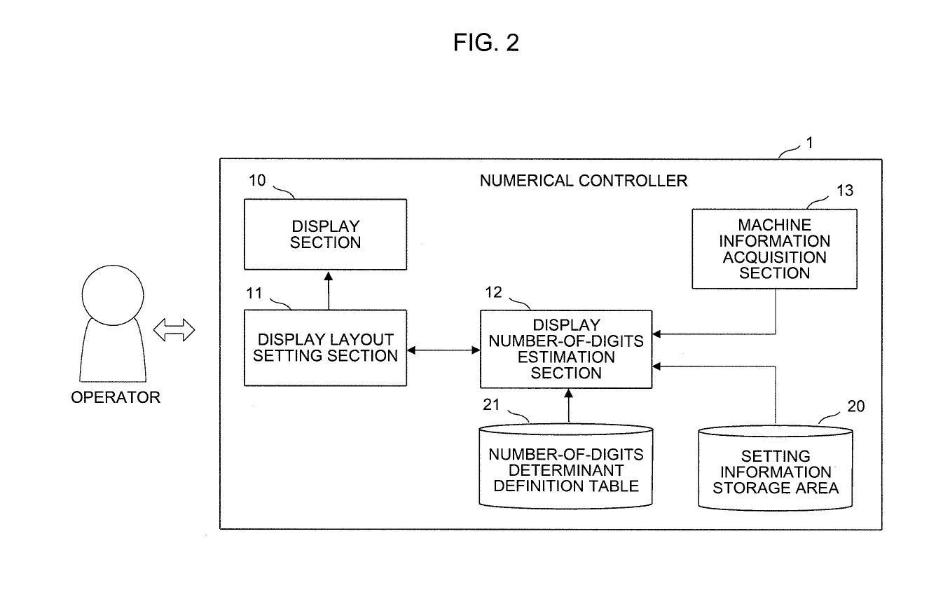

A numerical controller according to an embodiment of the present invention will be described with reference to FIG. 2.

A numerical controller 1 includes a display section 10, a display layout setting section 11, a display number-of-digits estimation section 12, a machine information acquisition section 13, a setting information storage area 20, and a number-of-digits determinant definition table 21.

The display section 10 displays the state of the numerical controller, the situation of processing, and other types of information on the screen on the basis of an operator's operation and other factors. The display section 10 displays, when it displays a variety of types of information representing the state and the situation on the screen, each type of control-related information to be displayed on the basis of a display layout set by the display layout setting section 11.

The display layout setting section 11 sets the display layout used when the display section 10 displays the control-related information to be drawn on the screen. The display layout setting section 11 determines the display layout, for example, on the basis of a layout processing routine implemented in advance. In the determination process, a display area used to display each type of control-related information is determined on the basis of a maximum possible display number of digits of the value of the control-related information. The maximum possible display number of digits of the value of each type of control-related information is determined on the basis of an estimation process carried out by the display number-of-digits estimation section 12.

The display number-of-digits estimation section 12 estimates the number of digits of each type of control-related information on the basis of information on a variety of settings of the numerical controller 1 stored in the setting information storage area 20, information on the setting of the machine acquired by the machine information acquisition section 13, and a factor relating to determination of the number of digits of each type of control-related information defined by the number-of-digits determinant definition table 21 and outputs a result of the estimation to the display layout setting section 11.

In the setting information storage area 20, information on the settings of the numerical controller 1 is defined. The information on the settings contains a settable range, a minimum setting unit, and other parameters of each type of control-related information that are used in the numerical controller 1.

The machine information acquisition section 13 acquires information relating to a machine to be controlled and outputs the information to the display number-of-digits estimation section 12. The information relating to a machine to be controlled and outputted to the display number-of-digits estimation section 12 may be acquired from a value set in advance by the operator in a memory area of the numerical controller 1 or may be acquired via an interface from the machine to be controlled. The information relating to a machine to be controlled contains a movement range (coordinate value range) and a minimum setting unit (information on number of digits after decimal point) of each axis of the machine, an offset value input range, the type of each axis (axis of translation or axis of rotation), and other types of information.

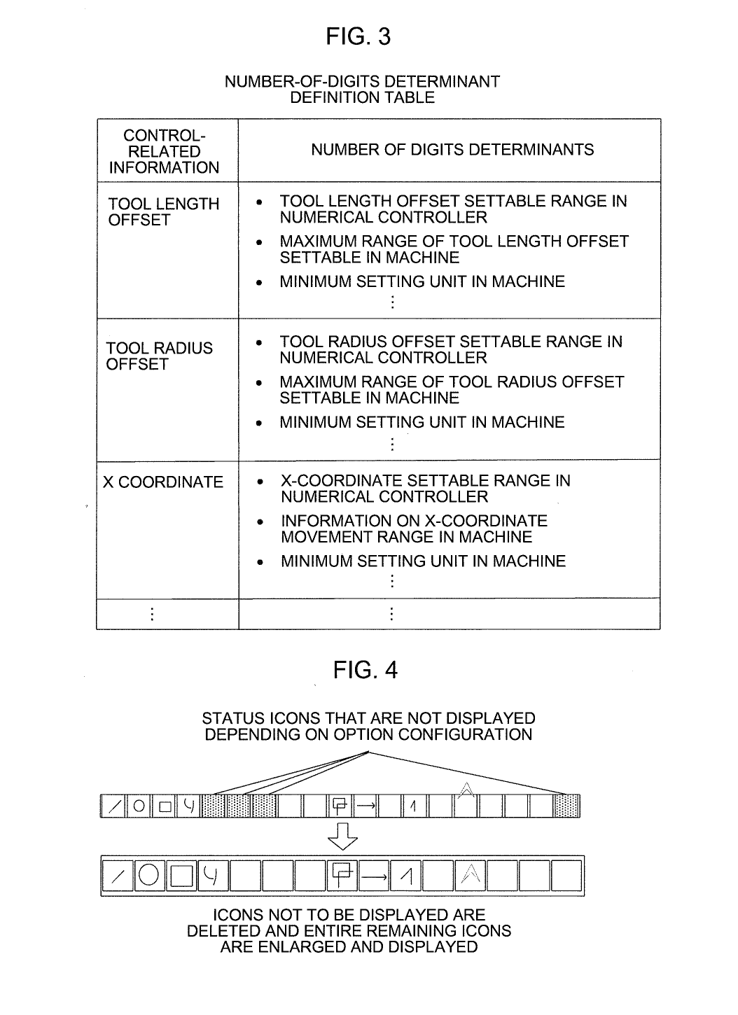

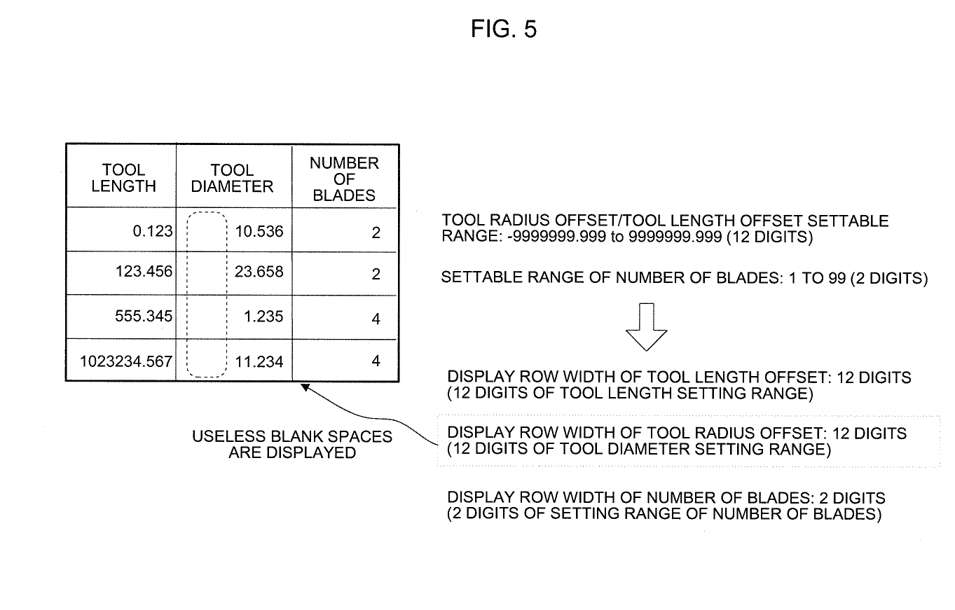

The number-of-digits determinant definition table 21 stores each type of control-related information in a state where it is associated with information that affects the range of the value of the control-related information. FIG. 3 shows an example of the number-of-digits determinant definition table 21.

In the number-of-digits determinant definition table 21 shown in FIG. 3, “a tool length offset settable range in the numerical controller,” which is information on a setting of the numerical controller, “a maximum range of the tool length offset settable in the machine” and “a minimum setting unit in the machine”, each of which is information on the machine, and the like are defined in relation to the range of possible values of the tool length offset.

The display number-of-digits estimation section 12, when it receives inquiry about a possible maximum display number of digits of the value of specific control-related information from the display layout setting section 11, first refers to the number-of-digits determinant definition table 21 and identifies information that affects the range of the value of the control-related information. The display number-of-digits estimation section 12 then acquires the identified information from the setting information storage area 20 and the machine information acquisition section 13 and estimates a possible maximum display number of digits of the value of the control-related information on the basis of the acquired information. The estimation is performed, for example, by extracting information that places a greatest constraint on the number of digits from the information acquired from the setting information storage area 20 and the machine information acquisition section 13.

For example, when the display number-of-digits estimation section 12 receives inquiry about the maximum display number of digits of the X coordinate, which is control-related information, from the display layout setting section 11, the display number-of-digits estimation section 12 refers to the number-of-digits determinant definition table 21 and determines that the range of possible values of X coordinates is affected, for example, by “the X-coordinate settable range in the numerical controller,” which is information of a setting of the numerical controller, “information on the X-coordinate movement range in the machine” and “the minimum setting unit in the machine,” each of which is information on the machine. Among them, as for the “X-coordinate settable range in the numerical controller,” referring to the setting information storage area 20 shows that possible X coordinates in the numerical controller ranges, for example, from −9999999.999 to 9999999.999. Further, as for the “information on the X-coordinate movement range in the machine” and “minimum setting unit in the machine,” referring to the information acquired from the machine information acquisition section 13 shows that X coordinate movement range in the machine ranges from −2000 to 2000 and that the X-coordinate minimum setting unit is formed of three digits after decimal point. As the range of possible values of the X coordinate is limited by “information on the X-coordinate movement range in the machine” to one digit for the sign plus four digits for numerals at the longest after decimal point and is limited by the “minimum setting unit in the machine” to three digits after decimal point, the display number-of-digits estimation section 12 estimates that the maximum possible number of digits of the X coordinate is nine digits as long as the machine is the control target and outputs the estimation result to the display layout setting section 11.

As described above, in the numerical controller 1, the display layout setting section 11 determines the display layout on the screen on the basis of the possible maximum display number-of-digits of each type of control-related information estimated by the display number-of-digits estimation section 12, and the display section 10 displays a variety of types of information on the basis of the determined display layout. The resultant display therefore excludes useless blank spaces from the screen, unlike in related art, whereby a larger amount of information can be simultaneously displayed on the screen.

A numerical controller according to another embodiment of the present invention will be described with reference to FIG. 4.

In the embodiment described above, the maximum display number of digits of each type of control-related information estimated by the display number-of-digits estimation section 12 is used to create the display layout on the screen. Applying the estimated maximum display number of digits to an input field of the numerical controller allows a prior check of whether a value of control-related information to be inputted by an operator falls within the range of a value actually used in a control process in terms of the range of number of digits. Such prior check allows automatic estimation of the range of possible values of each type of control-related information on the basis of information on the settings of the numerical controller 1 and information on a machine connected to the numerical controller 1, whereby a special effort to set the range of possible values of the control-related information can be saved, unlike the related art disclosed in Japanese Patent Application Laid-Open No. 2009-080621 described above.

The numerical controller according to the present invention is further applicable to a case where statuses of a machine are displayed in the form of icons, as shown in FIG. 4. In the state display using status icons shown in FIG. 4, the state of operation of a machine, information on a peripheral apparatus connected to the machine, and the like are displayed in the form of icons. Depending on an option configuration or a parameter configuration, some of the icons are always not displayed although the display areas thereof are saved, irrespective of the operation state and the connection state. In this case, by applying the present invention, a status icon to be displayed wastefully is specified by acquiring information on an option configuration, information on parameters, and the like provided in the machine, and then the display area of such an icon to be displayed wastefully is omitted, thereby allowing displaying any other type of information to be displayed instead or visibility of each of icons to be improved by enlarging the respective icons.

The embodiments according to the present invention have been described above, but the present invention is not limited only to the embodiments described above, and appropriate changes can be made thereto for implementation of the present invention in a variety of aspects.

1. A numerical controller having a function of displaying control-related information that is a value used in control process of a machine, the numerical controller comprising:
a setting information storage area that stores information on a setting of the numerical controller;
a machine information acquisition section that acquires information on the machine;
a number-of-digits determinant definition table that stores the control-related information and information that affects a range of possible values of the control-related information, from among the information on a setting of the numerical controller stored in the setting information storage area and the information on the machine acquired by the machine information acquisition section, in a state where the control-related information and the information that affects a range of possible values of the control-related information are associated with each other;
a display number-of-digits estimation section that refers, for each piece of the control-related information, to the number-of-digits determinant definition table to identify the information that affects a range of possible values of the control-related information and estimates, on the basis of the identified information, a maximum display number of digits of the control-related information;
a display layout setting section that sets a display layout on the basis of the maximum display number of digits of each element estimated by the display number-of-digits estimation section; and
a display section that displays the elements on the basis of the display layout set by the display layout setting section.

2. A numerical controller having a function of displaying, in the form of an icon, one or more states of a machine to be controlled by the numerical controller, the numerical controller comprising:
a setting information storage area that stores information on the machine and information on a setting of the numerical controller;
a display target state determination section that determines a state to be displayed, from among the one or more states, on the basis of the setting information storage area;
a display layout setting section that sets a display layout on the basis of the number of states to be displayed that is determined by the display target state determination section; and
a display section that displays the states to be displayed on the basis of the display layout set by the display layout setting section,
wherein the display layout setting section is configured to change a size of each of the icons in accordance with the number of states to be displayed.
